(19) United States
(12) Patent Application Publication
(10) Pub. No.: US 2008/0143233 A1
(43) Pub. Date: Jun. 19, 2008

(54) Low-Pressure Discharge Lamp

(75) Inventors: Holger Hein, Augsburg (DE); Paul Lange, Friedberg (DE); Thomas Noll, Kipfenberg (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, Munchen (DE)

(21) Appl. No.: 11/885,118

(22) PCT Filed: Feb. 6, 2006
(86) PCT No.: PCT/DE2006/000185

§ 371 Date: Aug. 27, 2007

(30) Foreign Application Priority Data
Feb. 28, 2005 (DE) 10 2005 009 055.9

(51) Int. Cl. H01J 61/64

(52) U.S. Cl. 313/318.08

(57) ABSTRACT

Disclosed is a low-pressure discharge lamp, particularly a compact fluorescent lamp comprising at least one discharge vessel that is inserted in a base. The base and the discharge vessel are connected via a joining material. According to the invention, the base is provided with at least one recess via which the joining material can be introduced after the discharge vessel has been inserted.

### TECHNICAL FIELD

The invention relates to a low-pressure discharge lamp in accordance with the precharacterizing clause of patent claim 1.

### PRIOR ART

Such low-pressure discharge lamps in the form of compact fluorescent lamps are described, for example, on the Internet domain www.osram.de under the product designations “DULUX® L, DULUX® D or DULUX® T”. In these lamps with a base at one end, the discharge vessel comprises one or more discharge vessels, which are bent in the form of a U and are inserted into a base and adhesively bonded to it. In order to make it possible to introduce the adhesive into the base, the base is designed in two parts, comprising a base upper and a base lower part. Disadvantages of the abovedescribed solution are firstly that such lamps have a high weight since the base parts overlap one another in the connection area and secondly that, owing to the required dimensional stability of the base parts, they are very expensive in terms of manufacture. Furthermore, owing to insufficient connection forces between the base parts, breakage of the base may result.

In order to simplify the manufacture and improve the strength, a low-pressure discharge lamp with a base in one part is known from the general prior art. In such lamps, an annular adhesive layer is applied to the inside of the base surface prior to insertion of the discharge lamp into the base, which adhesive layer is solid at room temperature and is activated after the discharge vessel has been inserted by means of heat input and brings about a fixed connection between the base and the discharge vessel. Although this solution allows for improved strength and simplified manufacture of the lamp, owing to the introduction of the adhesive before the lamp has been joined, it entails restrictions in terms of the selection of the adhesive and the manufacturing process since the adhesive needs to have a solid consistency at room temperature in order not to run away from the desired joint.

### DESCRIPTION OF THE INVENTION

The invention is based on the object of providing a low-pressure discharge lamp, in particular a compact fluorescent lamp, which has a low weight and a simplified production process.

This object is achieved by a low-pressure discharge lamp having the combination of features in claim 1. Particularly advantageous embodiments of the invention are described in the dependent claims.

The low-pressure discharge lamp according to the invention has at least one discharge vessel, which is inserted into a base and is connected to said base via a joining compound. According to the invention, the base has at least one cutout, via which the joining compound can be introduced when the discharge vessel has been inserted. This considerably simplifies the production of the lamp since the joining compound, in contrast to the prior art, does not need to be solid at room temperature and all suitable joining compounds and manufacturing processes can be used. Owing to the cutouts in the base, furthermore the use of materials and therefore the weight of the base can be considerably reduced. Via the cutouts according to the invention, the joining compound can be introduced in a targeted manner at the desired joints once the discharge vessel has been inserted. As a result, the strength of the base/discharge vessel joint is improved given minimal use of joining compound.

The base is preferably in one part, the strength of the base being further improved with a reduced weight.

In accordance with a particularly preferred exemplary embodiment, the cutout is arranged in a bottom wall of the base.

Preferably, the cutout is arranged centrally in the bottom wall and is matched with a constriction to the outer contour of the discharge vessel.

In a further development of the invention, the cutouts are arranged between connecting webs holding a base box.

An adhesive or cement is preferably used as the joining compound.

The joining compound is preferably introduced into an area, at least sections of which are delimited by the discharge vessel and the base.

Advantageously, at least two contact pins, which are used for making electrical contact with the low-pressure discharge lamp in the lampholder, and/or at least two connecting sleeves, in particular crimping sleeves for connecting a capacitor wire to a glow starter wire and an electrode wire, are fixed to the connecting webs. Since the crimping sleeves are inserted into the base, manufacture of the lamp is considerably simplified owing to the defined positioning of the wires.

In a further exemplary embodiment of the invention, four contact pins are fixed in the connecting webs.

It has proven to be particularly advantageous if the base box accommodates electrical components of the lamp, in particular an interference suppression capacitor and a glow starter.

The base is matched circumferentially substantially to the contour of the discharge vessel. As a result, the amount of material used is further reduced, the lamp weight is reduced and the design of the lamp is improved.

In accordance with a further exemplary embodiment, the lamp has a cover for covering the cutouts.

### BRIEF DESCRIPTION OF THE DRAWINGS

The invention will be explained in more detail below with reference to preferred exemplary embodiments. In the drawings:

FIG. 1 shows a three-dimensional view of a first exemplary embodiment according to the invention of a low-pressure discharge lamp in the form of a compact fluorescent lamp;

FIG. 2 shows a further three-dimensional view of the compact fluorescent lamp from FIG. 1;

FIG. 3 shows a three-dimensional view of a second exemplary embodiment of a compact fluorescent lamp according to the invention;

FIG. 4 shows a base of a further exemplary embodiment according to the invention of a compact fluorescent lamp;

FIG. 5 shows a three-dimensional view of an embodiment according to the invention of a compact fluorescent lamp, in which the discharge vessel is formed by a U-shaped glass tube, and

FIG. 6 shows a further three-dimensional view of the compact fluorescent lamp from FIG. 5.

### PREFERRED EMBODIMENTS OF THE INVENTION

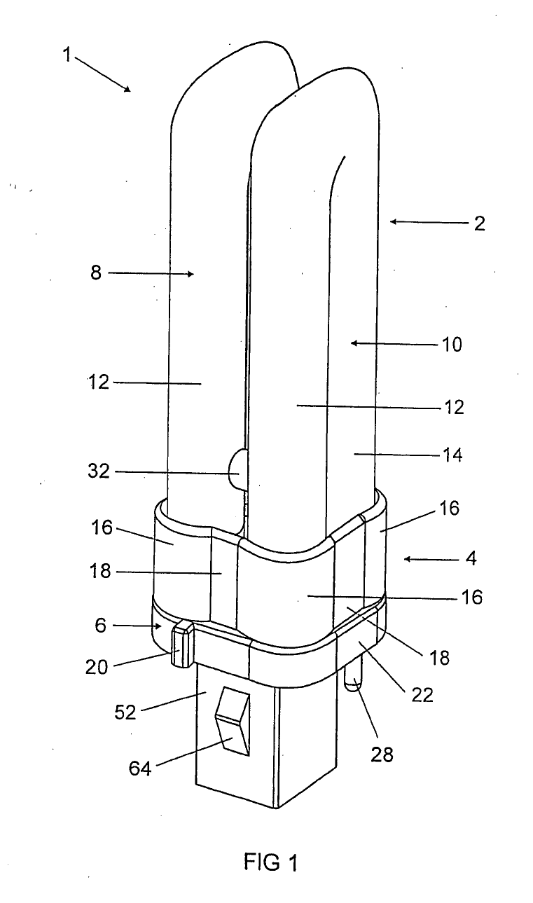

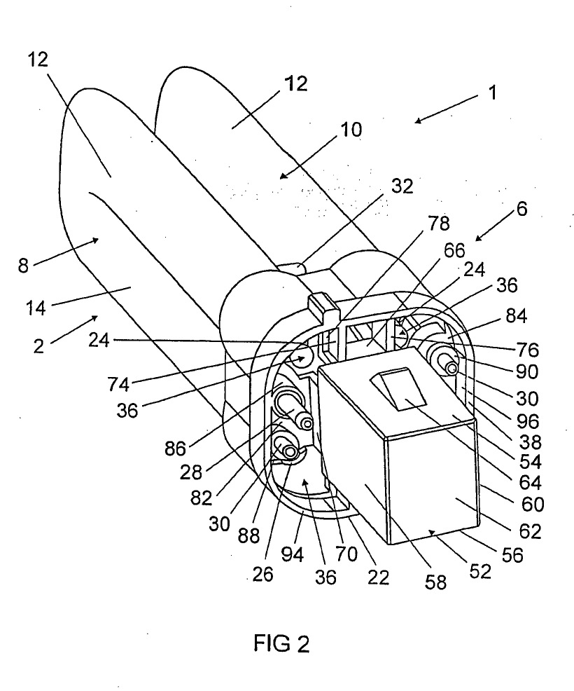

First, a first exemplary embodiment of a low-pressure discharge lamp according to the invention will be explained with reference to FIGS. 1 and 2, in which lamp the discharge vessel is formed by two U-shaped glass tubes.

FIG. 1 shows a low-pressure discharge lamp in the form of a compact fluorescent lamp 1 having a U-shaped discharge vessel 2, which is inserted into a holding region 4 of a single-part base 6. The discharge vessel 2 of the compact reference lamp 1 is formed by two U-shaped glass tubes 8, 10, which are arranged next to one another and each have two longitudinal tube sections 12, 14 running parallel to one another. The base 6 is matched to the contour of the discharge vessel 2 in the lamp-side holding region 4 by means of sections 16 in the form of segments of a cylinder which are connected via straight wall sections 18 and merges on the bottom side with a base collar 22 provided with coding tabs 20.

As shown in FIG. 2, the free ends of the longitudinal tube sections 12, 14 are sealed in a gas-tight manner by pinch seals 24, 26, in each case one pinch seal 26 of the longitudinal tube sections 14 bearing an electrode holder, which is fused in a gas-tight manner, with an electrode (not illustrated), which is connected in each case via two power supply lines to contact pins 28 or crimping sleeves 30 pressed into the base. The two U-shaped glass tubes 8, 10 are arranged one behind the other such that the two longitudinal tube sections 12, 14 each lie in planes running parallel to one another, the pinch seals 26 provided with the power supply lines being located on the same side (at the bottom in FIG. 2). The interiors of the glass tubes 8, 10 communicate via a hollow connecting web 32, with the result that a single continuous discharge space is produced. The discharge vessel 2 is connected to the base 6 via a joining compound 34. According to the invention, the base 6 has cutouts 36, via which the joining compound 34, for example a hot-melt adhesive or a two-component adhesive, can be introduced into the base 6 once the discharge vessel 2 has been inserted. In the exemplary embodiment shown in FIG. 1 and FIG. 2, the cutouts 36 are arranged in a base bottom 38 between connecting webs 74, 76, 82, 84, which hold a base box 52 approximately centrally on the base 6. The adhesive is injected substantially into corner regions of the base 6 via the cutouts 36, and as a result the free ends of the longitudinal tube sections 12, 14 are adhesively bonded to the base 6. The adhesive 34 can be introduced in a targeted manner at the desired joints via the cutouts 36 once the discharge vessel 2 has been inserted. This improves the strength of the joint with minimized consumption of adhesive. Furthermore, owing to the cutouts 36 in the base 6, the amount of material used and therefore the weight of the base 6 are considerably reduced.

As can be seen in particular in FIG. 2, the base box 52 substantially has a rectangular cross section with four side faces 54 to 60 and a basal face 62. The base box 52 is in the form of a hollow body so as to accommodate an interference suppression capacitor and a glow starter (not illustrated). Latching projections 64 with an approximately triangular cross section are arranged at the side faces 54, 56 of the base box 52. The compact fluorescent lamp 1 can be inserted into a lampholder (not illustrated) via the base box 52, the latching projections 64 engaging around holding springs arranged in the lampholder and thus holding the lamp 1 in the lampholder. The side faces 54 to 60 of the base box 52 merge on the lamp side with four plate-shaped projections 66 to 72 having a reduced width in comparison with the box 6, which projections extend into the approximately annular base collar 22 of the base 6. In each case two approximately L-shaped connecting webs 74, 76, which are arranged parallel to one another and are spaced apart from one another, are formed on mutually opposite projections 66, 68 (projection 68 is covered by the base box), the shorter limbs 78 of the connecting webs 74, 76 terminating flush with the side faces of the projections 66, 68. The two projections 70, 72 which are opposite one another (projection 72 is covered by the base box) merge on the lamp side approximately in the form of an L with two connecting webs 82, 84, which are widened in arcuate fashion toward the base collar 22.

In each case one of the contact pins 28 and one of the crimping sleeves 30 is pressed into cylindrical attachments 86 to 92 (the attachment 92 is covered by the base box) on the two connecting webs 82, 84. The attachments 86, 92 for accommodating the contact pins 28 terminate flush with a bottom face 94 of the base 6 and are connected to an inner face 96 of the base collar 22. The attachments 88, 90 of the crimping sleeves 30 are shorter than the attachments 86, 92 of the contact pins 28 and are each used for connecting a capacitor wire to a glow starter wire and an electrode wire (not illustrated). On the left-hand side in FIG. 1, the contact pin 28 is arranged above the crimping sleeve 30, and on the right-hand side it is arranged below the crimping sleeve 30. Electrical contact is made with the compact fluorescent lamp 1 in the lampholder via the two contact pins 28.

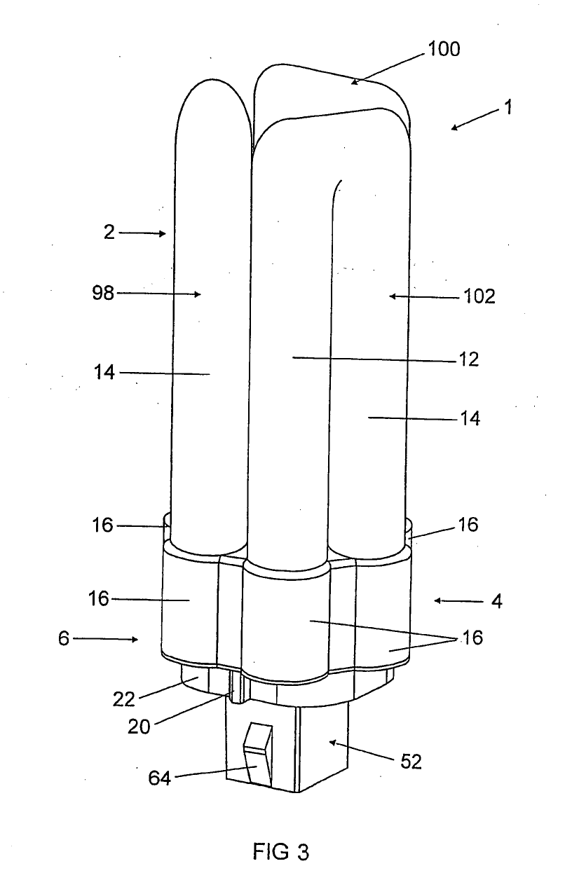

FIG. 3 shows a three-dimensional illustration of the compact fluorescent lamp 1 according to the invention corresponding to a second exemplary embodiment. This exemplary embodiment differs from the abovedescribed exemplary embodiment substantially by the fact that the discharge vessel 2 of the compact fluorescent lamp 1 is formed by three U-shaped glass tubes 98, 100, 102, which are arranged such that the planes in which the longitudinal tube sections 12, 14 of each glass tube 98 to 102 lie form, in section, an approximately equilateral triangle. As has already been explained, the base 6 is substantially matched to the contour of the discharge vessel 2 in a lamp-side holding region 4 and merges with the approximately annular base collar 22 on the bottom side.

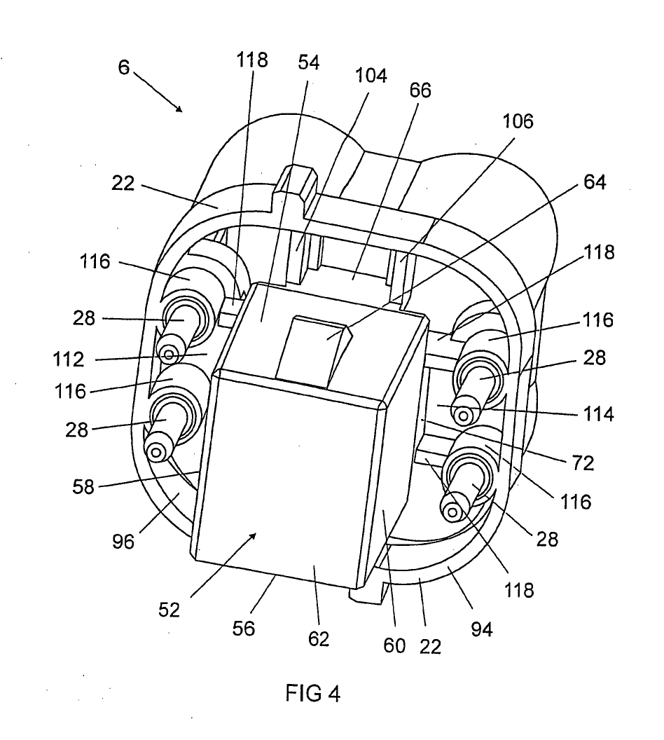

FIG. 4 illustrates a further embodiment according to the invention in which the discharge vessel is formed by two glass tubes. Since the arrangement of the discharge vessel corresponds to that shown in FIGS. 1 and 2, only the base 6 of the compact fluorescent lamp 1 is illustrated in FIG. 4. This likewise has a centrally arranged base box 52, which is connected to the base collar 22 via connecting webs. The side faces 54 to 60 of the base box 52 merge with four plate-shaped projections 66, 68, 70, 72 having a smaller width than the base 6 on the lamp side, as has already been explained, which projections extend into the approximately annular base collar 22 of the base 6. In each case two approximately L-shaped connecting webs 104, 106, which are arranged parallel to one another and are spaced apart from one another, are formed on two first projections 66, 68, the side faces of the longer limb terminating flush with the side faces of the projections 66, 68. The two further projections 70, 72 in each case merge approximately in the form of an L on the lamp side with a further connecting web 112, 114, which widens in arcuate fashion toward the base collar 22. In each case two contact pins 28 are pressed into cylindrical attachments 116 on the two connecting webs 112, 114, which attachments terminate flush with the bottom face 94 of the base 6 and are connected to the inner face 96 of the base collar 22. In each case one reinforcing rib 118, which terminates flush with the side faces of the connecting webs 112, 114 and is set back axially with respect to the attachments 116, is assigned to the attachments 116. In this exemplary embodiment, the latching projections 64 which are arranged on the side faces 54, 56, terminate flush with the basal face 62 of the base box 52. Once the compact fluorescent lamp 1 has been inserted into the lampholder, electrical contact is made via the four contact pins 28, which are connected to the electrical components and the electrodes (not illustrated).

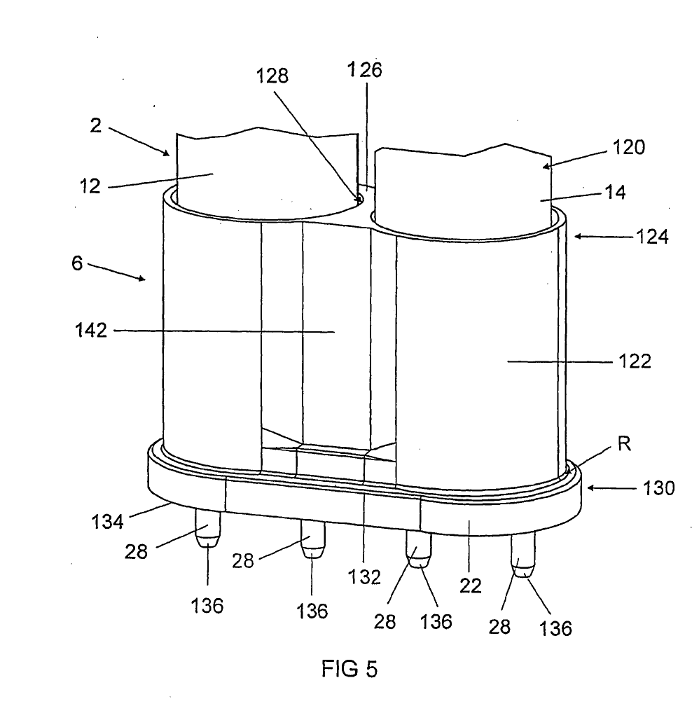

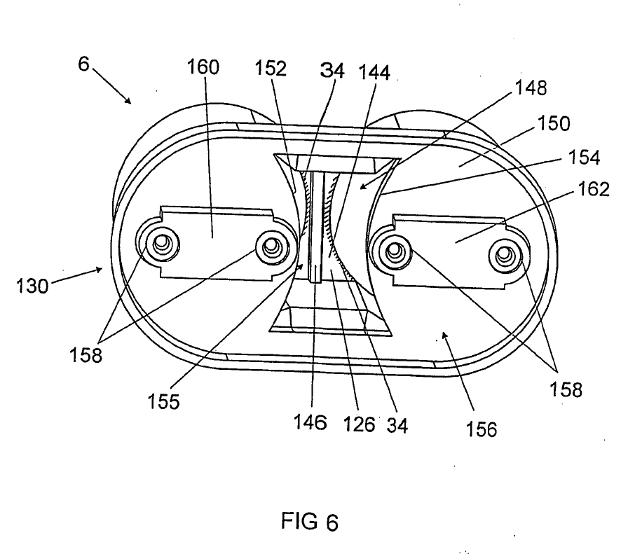

FIG. 5 and FIG. 6 illustrate an exemplary embodiment of a compact fluorescent lamp according to the invention, in which the discharge vessel 2 is formed by a single glass tube 120 bent in the form of a U. As can be seen in particular in FIG. 5, the base 6 has a substantially oval basic body 122, which has a centrally arranged web-shaped wall 126 with a constriction 128, which is matched to the outer contour of the discharge vessel 2, on a lamp-side end section 124. The base 6 merges with the base collar 22, which has been provided with a circumferential bevel 132, in stepwise fashion at a bottom-side end section 130 via a radius R. Four contact pins 28 arranged in a row are pressed into the base 6 along the plane formed by the longitudinal tube sections 12, 14 on a base underside 134. The contact pins 28 are each provided with a front-side bevel 136 in order to facilitate the insertion of the lamp 1 into the lampholder (not illustrated). Cutouts 142 for reducing the weight are provided on two opposite side faces of the base 6.

As shown in FIG. 6, which shows a further view of the compact fluorescent lamp from FIG. 5, the base 6 is in the form of a hollow body, and the web-shaped wall 126 is provided with a centrally arranged additional reinforcing rib 146 having a rectangular cross section along an inner face 144. In this exemplary embodiment, a single cutout 148 is arranged centrally in a bottom wall 150 of the base 6 and, by means of arcuate side faces 152, 154, which form a constriction 155, is matched to the outer contour of the discharge vessel (not illustrated). The adhesive 34 is introduced into the regions indicated by hatching via the cutout 148 once the discharge vessel has been inserted, and a fillet weld is formed there between the wall and the discharge vessel. Owing to the targeted introduction of the adhesive 34, the strength of the joint is improved given minimized use of adhesive. The bottom-side end section 130 is provided with a cutout 156 in such a way that the stepped drilled holes 158 of the contact pins are arranged on two approximately rectangular elevations 160, 162. These elevations are expanded in the region of the drilled holes 158, i.e. on their narrow sides in each case in the form of a semicircle, and allow for a stable press-in face for the contact pins 28 (see FIG. 5) given a reduced base weight.

The low-pressure discharge lamp 1 according to the invention is not restricted to the exemplary embodiments explained above. Thus, for example, the discharge vessel 2 may be in the form of a rod or ring and/or may comprise more than three glass tubes. Furthermore, the glass tubes may also form a plurality of discharge vessels 2 having separate discharge spaces. It is likewise possible to close the cutouts 36, 148 in the base 6 via a cover. The invention discloses a low-pressure discharge lamp 1, in particular a compact fluorescent lamp having at least one discharge vessel, which is inserted into a base 6, the base 6 and the discharge vessel 2 being connected via a joining compound 34. According to the invention, the base 6 has at least one cutout 36, 148, via which the joining compound 34 can be introduced when the discharge vessel 2 has been inserted.

1. A low-pressure discharge lamp, in particular a compact fluorescent lamp (1) having at least one discharge vessel (2), which is inserted into a base (6), the base (6) and the discharge vessel (2) being connected via a joining compound (34), characterized in that the base (6) has at least one cutout (36, 148), via which the joining compound (34) can be introduced when the discharge vessel (2) has been inserted.

2. The low-pressure discharge lamp as claimed in claim 1, the cutout (148) being formed in a bottom wall (150) of the base (6).

3. The low-pressure discharge lamp as claimed in claim 2, the cutout (148) being arranged centrally in the bottom wall (150) and being matched with a constriction (155) to the outer contour of the discharge vessel (2).

4. The low-pressure discharge lamp as claimed in claim 1, the cutout (36) being arranged between connecting webs (74, 76, 82, 84, 104, 106, 112, 114) holding a base box (52).

5. The low-pressure discharge lamp as claimed in claim 4, the base box (52) accommodating electrical components, in particular an interference suppression capacitor and a glow starter.

6. The low-pressure discharge lamp as claimed in claim 4, at least two contact pins (28) and/or at least two connecting sleeves (30), in particular crimping sleeves for connecting a capacitor wire to a glow starter wire and an electrode wire, are fixed to the connecting webs (74, 76, 82, 84; 104, 106, 112, 114).

7. The low-pressure discharge lamp as claimed in claim 6, four contact pins (28) being fixed to the connecting webs (104, 106, 112, 114).

8. The low-pressure discharge lamp as claimed in claim 1, the joining compound (34) being introduced into an area, at least sections of which are delimited by the discharge vessel (2) and the base (6).

9. The low-pressure discharge lamp as claimed in claim 1, the joining compound (34) being an adhesive or cement.

10. The low-pressure discharge lamp as claimed in claim 1, the base (6) being in one part.

11. The low-pressure discharge lamp as claimed in claim 1, the base (6) being matched circumferentially substantially to the contour of the discharge vessel (2).

12. The low-pressure discharge lamp as claimed in claim 1 having a cover for covering the cutouts (74, 76, 82, 84, 104, 106, 112, 114).
